(19) United States
(12) Patent Application Publication
(10) Pub. No.: US 2026/0359714 A1
(43) Pub. Date: Nov. 12, 2026

(54) METHODS FOR ML MODEL PERFORMANCE AND CORRECTNESS MONITORING IN A WIRELESS SYSTEM

(71) Applicant: InterDigital Patent Holdings, Inc., Wilmington, DE (US)

(72) Inventors: Chonggang Wang, Princeton, NJ (US); Michel Roy, Candiac (CA); Quang Ly, North Wales, PA (US); Lu Liu, Conshohocken, PA (US); Dale Seed, Allentown, PA (US); Ulises Olvera-Hernandez, Saint-Lazare (CA)

(73) Assignee: InterDigital Patent Holdings, Inc., Wilmington, DE (US)

(21) Appl. No.: 19/203,059

(22) Filed: May 8, 2025

(51) Int. Cl. G06N 20/00

(52) U.S. Cl. CPC G06N 20/00

(57) ABSTRACT

A model performance and correctness monitoring function (MPCMF) may provide a service for model evaluation and model monitoring supporting one or more of the following capabilities including MPCMF receiving model performance and correctness monitoring instructions (MPCMI) and test vector sets from an application function (AF), MPCMF preparing and distributing MPCMIs and test vector sets to inference nodes (INs), such as WTRUs, INs performing ML model performance and correctness evaluations using MPCMIs and test vector sets and generating model performance and correctness evaluation reports (MPCERs), and MPCMF collecting MPCERs from INs. The definition of the MPCMF functional entity, procedures, and information flows are hereby provided.

### BACKGROUND

Machine learning (ML) model performance and correctness evaluation is a technique that may enable the evaluation of performance metrics such as accuracy, precision, sensitivity, root mean square error (RMSE) of deployed ML models. To effectively evaluate the performance and correctness of an ML model, ground truth data is typically required. This ground truth data may be used to verify that the ML model produces the expected outputs for given inputs. However, to accurately evaluate the performance and correctness of an ML model, this ground truth data must be representative of the input data the model is consuming during real-world operation. Since the distribution and statistical properties of input data as well as the relationships between input data and output data may change over time (i.e., data and model drifts), the ground truth data used to evaluate the performance and correctness of an ML model may need to be updated. Determining if and/or when updates to ground truth data are required such that the performance and correctness of an ML model can be effectively evaluated may not be trivial to determine.

### SUMMARY

A model performance and correctness monitoring function (MPCMF) may provide a service for model evaluation and model monitoring supporting one or more of the following capabilities including MPCMF receiving model performance and correctness monitoring instructions (MPCMI) and test vector sets from an application function (AF), MPCMF preparing and distributing MPCMIs and test vector sets to inference nodes (INs), such as WTRUs, INs performing ML model performance and correctness evaluations using MPCMIs and test vector sets and generating model performance and correctness evaluation reports (MPCERs), and MPCMF collecting MPCERs from INs. The definition of the MPCMF functional entity, procedures, and information flows are hereby provided.

A system, device and method for model performance and correctness monitoring for terminal devices are described. The method includes acquiring, by a wireless transmit and receive unit (WTRU), instructions for machine learning (ML) model performance and correctness monitoring from a network, acquiring, by the WTRU, ML model test vectors from the network, determining, by the WTRU, to perform an ML model performance and correctness evaluation, determining, by the WTRU, based on the ML model test vectors, a performance and correctness of the ML model, generating, by the WTRU, a report for a ML model performance and correctness monitoring according to the acquired instructions, and sending the generated report to the network.

The method may include wherein the acquired instructions includes at least one of an identifier for an MPCMI, a creator identifier, one or more test vectors, a test vector set identifier, a test vector set address, one or more model performance and correctness evaluation rule, a reporting configuration, and MPCMI scope, wherein MPCMI scope comprises of ML model profile identifier, ML model identifier, and inference node (IN) selection criteria. The method may includewherein the report comprises of one or more of a MPCER identifier, a creator identifier, an MPCMI identifier, a test vector set identifier, a ML model profile identifier, a ML model identifier, hyperparameters used for model evaluation, and model performance and correctness evaluation outcomes, wherein model performance and correctness evaluation outcomes comprises one or more of a test vector identifier, a test output, and user feedback. The method may include wherein the acquiring instructions includes at least one of the WTRU receiving MPCMI within a received ML model retrieval response from the network, receiving MPCMI within a received ML model deployment request from the network, the WTRU retrieving MPCMI from the network, or the WTRU subscribing to the network and receiving MPCMI in a notification. The method may includewherein the acquiring ML model test vectors includes at least one of receiving ML model test vectors embedded within an MPCMI or retrieving ML model test vectors from the network using a ML model identifier or test vector set address provided in an MPCMI. The method may include wherein the determining to perform an ML model performance and correctness evaluation includes at least one of receiving a request from an artificial intelligence machine learning (AIMLE) server to trigger an ML model performance and correctness evaluation or triggering an ML model performance and correctness evaluation based on an MPCMI. The method may include wherein the determining the performance and correctness of the ML model includes the WTRU providing model test vectors into the ML model and generating model inference outputs. The method may includewherein the determining the performance and correctness of the ML model includes the WTRU determining ML model performance metrics by comparing inference outputs of the ML model to test vector outputs, wherein the ML model performance metric comprise one or more of accuracy, precision, correctness, sensitivity, recall, F1 score, mean absolute error, mean square error, root mean square error, and R2 score.

A system, device and method for model performance and correctness monitoring for network service are described. The method includes receiving one or more requests from an AF to configure instructions for a ML model performance and correctness monitoring and ML model test vectors, sending the instructions to a wireless transmit and receive unit (WTRU), sending ML model test vectors to the WTRU, receiving a message including a WTRU identifier, ML model identifier and ML model performance and correctness evaluation results (MPCER), and sending a MPCER to an AF.

The method may further include receiving a request from a WTRU to access at least one of ML model performance and correctness monitoring instructions (MPCMI) and ML model test vectors. The method may include wherein receiving a request from a WTRU to access MPCMI includes at least one of a retrieve request or a subscribe request. The method may include wherein the receiving one or more requests from an AF includes receiving ML model test vectors which may be embedded within an MPCMI. The method may include wherein the instructions include an identifier for the MPCMI, a creator identifier, one or more test vectors, a test vector set identifier, test vector set address, one or more model performance and correctness evaluation rule, a reporting configuration, and MPCMI scope, wherein MPCMI scope comprises of ML model profile identifier, ML model identifier, and inference node (IN) selection criteria. The method may include wherein the sending the instructions includes sending MPCMI to the WTRU in at least one of an ML model retrieval response, an ML model deployment request, a retrieve response, or a notification. The method may include wherein the MPCER comprises of one or more of a MPCER identifier, a creator identifier, an MPCMI identifier, a test vector set identifier, a ML model profile identifier, a ML model identifier, hyperparameters used for model evaluation, and model performance and correctness evaluation outcomes, wherein model performance and correctness evaluation outcomes comprises one or more of a test vector identifier, a test output, and user feedback. The method may include wherein the receiving a request from a WTRU to access ML model test vectors includes at least one of a retrieve request for ML model test vectors, an MPCMI retrieve request, or an MPCMI subscribe request, wherein the MPCMI comprises ML model test vectors. The method may include wherein the sending ML model test vectors to the WTRU includes sending ML model test vectors to the WTRU within at least one of an ML model retrieval response, an ML model deployment request, an ML model test vector retrieve response, an MPCMI retrieve response, wherein the MPCMI comprises ML model test vectors. The method may include wherein the sending ML model test vectors to the WTRU includes at least one of sending ML model test vectors to the WTRU within an ML model deployment request, sending AIML test vectors to the WTRU in an ML model test vector retrieve response, or sending AIML test vectors to the WTRU in an MPCMI retrieve response, wherein the MPCMI comprises ML model test vectors. The method may include wherein the sending ML model test vectors to the WTRU includes sending ML model test vectors to the WTRU in an MPCMI notification, wherein the MPCMI notification comprises ML model test vectors. The method may include wherein the receiving a message including a WTRU identifier, ML model identifier and MPCER includes at least one of receiving MPCER information in an MPCER retrieve response from the WTRU or receiving MPCER information in an MPCER notification from the WTRU.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates a high-level overview of an ML model lifecycle;

FIG. 3 illustrates a high-level ML model performance and correctness monitoring lifecycle;

FIG. 4 illustrates a flow diagram for supporting MPCMI provisioning to MPCMF and/or to an ML repository;

FIG. 5 illustrates a flow diagram for supporting MPCMI provisioning during model deployment where model deployment and MPCMI provisioning are concurrently performed;

FIG. 6 illustrates a flow diagram for supporting IN(s) obtaining MPCMIs from MPCMF;

FIG. 7 illustrates a flow diagram of a network triggered model performance and correctness evaluation procedure;

FIG. 8 illustrates a flow diagram for supporting the ML model evaluation triggered by the WTRU;

FIG. 9 illustrates a method for model performance and correctness monitoring for terminal devices; and

FIG. 10 illustrates a method for model performance and correctness monitoring for network service.

### DETAILED DESCRIPTION

“WTRU” and “UE” may be used interchangeably. “AIML model”, “ML model”, and “model” may be used interchangeably. “ML Repository” and “ML Model Repository” may be used interchangeably. “Reference data”, “labeled data”, “verified data”, “true value”, “true data”, “actual value”, “actual data” and “ground truth data” may be used interchangeably. “Application Function (AF)” refers to but is not limited to a logical server function that may be provided by an Application Server (AS), an Edge Application Server (EAS), and a Cloud Application Server (CAS). An AF is a functional element in the application layer (e.g., above the core network) and may be an application enablement functional entity (e.g., AIMLE server, ML model repository, SEAL server, EES, ECS, etc.) or any third-party functional entity (e.g., a VAL server). “Application Client (AC)” refers to but is not limited to a logical function that is provided by an application present on a UE. “Inference Node (IN)” refers to a node that hosts one or multiple models for model inference. An IN may be a WTRU, a network function (e.g., NWDAF), an AF (e.g., AS/EAS/CAS), an AIMLE Server, an ADAE Server. “ML model performance” describes how well an ML model achieves its task across a range of evaluation metrics such as precision, accuracy, confidence, latency and other metrics such as F1 Score, AUC-ROC, and RMSE). For example, an ML model that achieves a 95% accuracy may be considered as high performing. “ML model correctness” describes whether the model outputs are correct (e.g., logically and factually) according to a known ground truth. For example, an ML model predicting an impossible result may be considered incorrect even if its average accuracy is high. “ML model evaluation” describes the process of determining model performance and correctness based on test vector sets. “ML model monitoring” describes a framework to provide the means of automating ML model evaluation. “Test vector”, “test vector set”, “test vector instances” and “test vector sample” may be used interchangeably and refer to inputs and expected outputs used to evaluate the performance and correctness of ML model(s). “Model Performance and Correctness Monitoring Function (MPCMF)” refers to a logical function that may provide services for monitoring performance and correctness of models at INs. MPCMF may be collocated with a network function (e.g., NWDAF), an AIMLE Server, an ADAE Server, an ML Repository, etc. “Model Performance and Correctness Monitoring Instructions (MPCMI)” refers to instructions for facilitating, scheduling, coordinating, and/or specifying scopes, rules, conditions, test vectors and other information about monitoring performance and correctness of one or multiple models at INs. “MPCMI”, “Monitoring Instructions”, “Monitoring Policies”, “Monitoring Rules”, “Evaluations Instructions”, “Evaluations Policies”, and “Evaluation Rules” may be used interchangeably. “Model Performance and Correctness Evaluation Report (MPCER)” refers to a report comprising AI model performance and correctness evaluation outcomes for one or multiple models at INs. “MPCER”, “Monitoring Reports”, “Monitoring Results”, “Monitoring Feedback”, “Evaluations Reports”, “Evaluation Results”, and “Evaluation Feedback” may be used interchangeably.

The systems, methods and devices define the ML model performance and correctness monitoring function (MPCMF) capability. The MPCMF capability may be offered as a service in future wireless systems. The service may be deployed in the core network of a wireless system or within an application enablement layer of a wireless system. The service may be deployed in a distributed manner where some capabilities of the service may be deployed in the network (e.g., server-side capabilities) and other capabilities on WTRUs (e.g., client-side capabilities).

A WTRU may receive ML model performance and correctness monitoring instructions, and ML model test vectors from the MPCMF in the network. Based on these instructions and test vectors, the WTRU may perform an ML model performance and correctness evaluation to determine the performance and correctness of an ML model. The WTRU may generate an ML model performance and correctness monitoring report comprising the determined performance and correctness of the ML model and sends this information to the network.

A MPCMF in the network (e.g., AIMLE server) may receive one or more requests from an AF to configure ML model performance and correctness instructions and ML model test vectors. The MPCMF may receive one or more requests from a WTRU to access ML model performance and correctness monitoring instructions and ML model test vectors. The MPCMF may send ML model performance and correctness monitoring instructions and ML model test vectors to the WTRU. The MPCMF may receive a message including a WTRU identifier, ML model identifier and ML model performance and correctness evaluation results from the WTRU. The MPCMF may send the results to an AF.

A system, device and method for model performance and correctness monitoring for terminal devices are described. The method includes acquiring, by a wireless transmit and receive unit (WTRU), instructions for machine learning (ML) model performance and correctness monitoring from a network, acquiring, by the WTRU, ML model test vectors from the network, determining, by the WTRU, to perform an ML model performance and correctness evaluation, determining, by the WTRU, based on the ML model test vectors, a performance and correctness of the ML model, generating, by the WTRU, a report for a ML model performance and correctness monitoring according to the acquired instructions, and sending the generated report to the network.

The method may include wherein the acquired instructions includes at least one of an identifier for an MPCMI, a creator identifier, one or more test vectors, a test vector set identifier, a test vector set address, one or more model performance and correctness evaluation rule, a reporting configuration, and MPCMI scope, wherein MPCMI scope comprises of ML model profile identifier, ML model identifier, and inference node (IN) selection criteria. The method may includewherein the report comprises of one or more of a MPCER identifier, a creator identifier, an MPCMI identifier, a test vector set identifier, a ML model profile identifier, a ML model identifier, hyperparameters used for model evaluation, and model performance and correctness evaluation outcomes, wherein model performance and correctness evaluation outcomes comprises one or more of a test vector identifier, a test output, and user feedback. The method may include wherein the acquiring instructions includes at least one of the WTRU receiving MPCMI within a received ML model retrieval response from the network, receiving MPCMI within a received ML model deployment request from the network, the WTRU retrieving MPCMI from the network, or the WTRU subscribing to the network and receiving MPCMI in a notification. The method may includewherein the acquiring ML model test vectors includes at least one of receiving ML model test vectors embedded within an MPCMI or retrieving ML model test vectors from the network using a ML model identifier or test vector set address provided in an MPCMI. The method may include wherein the determining to perform an ML model performance and correctness evaluation includes at least one of receiving a request from an artificial intelligence machine learning (AIMLE) server to trigger an ML model performance and correctness evaluation or triggering an ML model performance and correctness evaluation based on an MPCMI. The method may include wherein the determining the performance and correctness of the ML model includes the WTRU providing model test vectors into the ML model and generating model inference outputs. The method may includewherein the determining the performance and correctness of the ML model includes the WTRU determining ML model performance metrics by comparing inference outputs of the ML model to test vector outputs, wherein the ML model performance metric comprise one or more of accuracy, precision, correctness, sensitivity, recall, F1 score, mean absolute error, mean square error, root mean square error, and R2 score.

A system, device and method for model performance and correctness monitoring for network service are described. The method includes receiving one or more requests from an AF to configure instructions for a ML model performance and correctness monitoring and ML model test vectors, sending the instructions to a wireless transmit and receive unit (WTRU), sending ML model test vectors to the WTRU, receiving a message including a WTRU identifier, ML model identifier and ML model performance and correctness evaluation results (MPCER), and sending a MPCER to an AF.

The method may further include receiving a request from a WTRU to access at least one of ML model performance and correctness monitoring instructions (MPCMI) and ML model test vectors. The method may include wherein receiving a request from a WTRU to access MPCMI includes at least one of a retrieve request or a subscribe request. The method may include wherein the receiving one or more requests from an AF includes receiving ML model test vectors which may be embedded within an MPCMI. The method may include wherein the instructions include an identifier for the MPCMI, a creator identifier, one or more test vectors, a test vector set identifier, test vector set address, one or more model performance and correctness evaluation rule, a reporting configuration, and MPCMI scope, wherein MPCMI scope comprises of ML model profile identifier, ML model identifier, and inference node (IN) selection criteria. The method may include wherein the sending the instructions includes sending MPCMI to the WTRU in at least one of an ML model retrieval response, an ML model deployment request, a retrieve response, or a notification. The method may include wherein the MPCER comprises of one or more of a MPCER identifier, a creator identifier, an MPCMI identifier, a test vector set identifier, a ML model profile identifier, a ML model identifier, hyperparameters used for model evaluation, and model performance and correctness evaluation outcomes, wherein model performance and correctness evaluation outcomes comprises one or more of a test vector identifier, a test output, and user feedback. The method may include wherein the receiving a request from a WTRU to access ML model test vectors includes at least one of a retrieve request for ML model test vectors, an MPCMI retrieve request, or an MPCMI subscribe request, wherein the MPCMI comprises ML model test vectors. The method may include wherein the sending ML model test vectors to the WTRU includes sending ML model test vectors to the WTRU within at least one of an ML model retrieval response, an ML model deployment request, an ML model test vector retrieve response, an MPCMI retrieve response, wherein the MPCMI comprises ML model test vectors. The method may include wherein the sending ML model test vectors to the WTRU includes at least one of sending ML model test vectors to the WTRU within an ML model deployment request, sending AIML test vectors to the WTRU in an ML model test vector retrieve response, or sending AIML test vectors to the WTRU in an MPCMI retrieve response, wherein the MPCMI comprises ML model test vectors. The method may include wherein the sending ML model test vectors to the WTRU includes sending ML model test vectors to the WTRU in an MPCMI notification, wherein the MPCMI notification comprises ML model test vectors. The method may include wherein the receiving a message including a WTRU identifier, ML model identifier and MPCER includes at least one of receiving MPCER information in an MPCER retrieve response from the WTRU or receiving MPCER information in an MPCER notification from the WTRU.

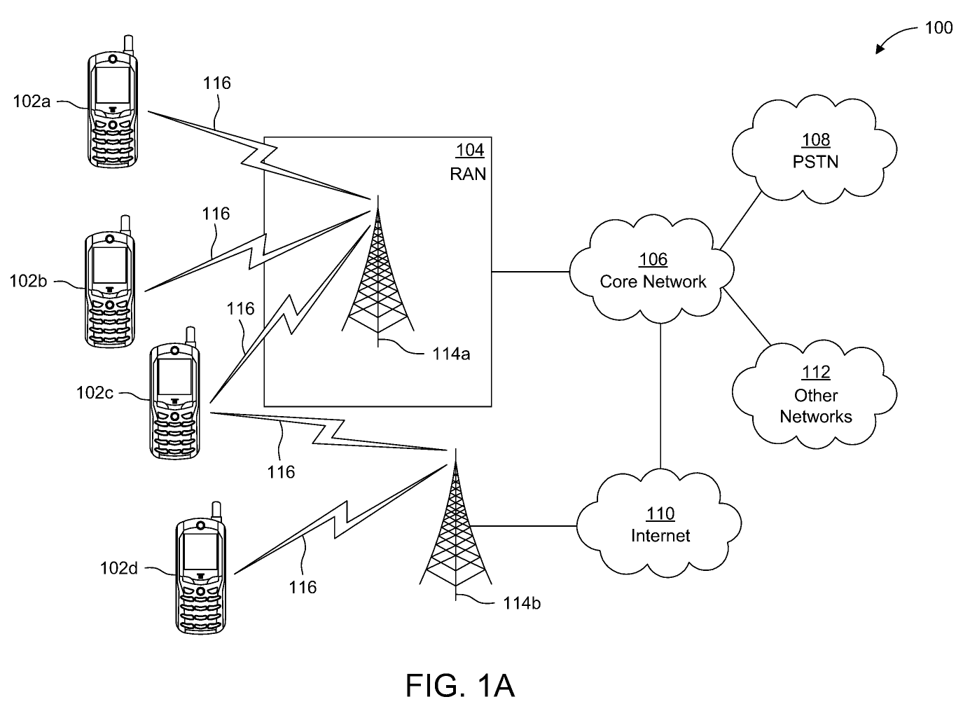

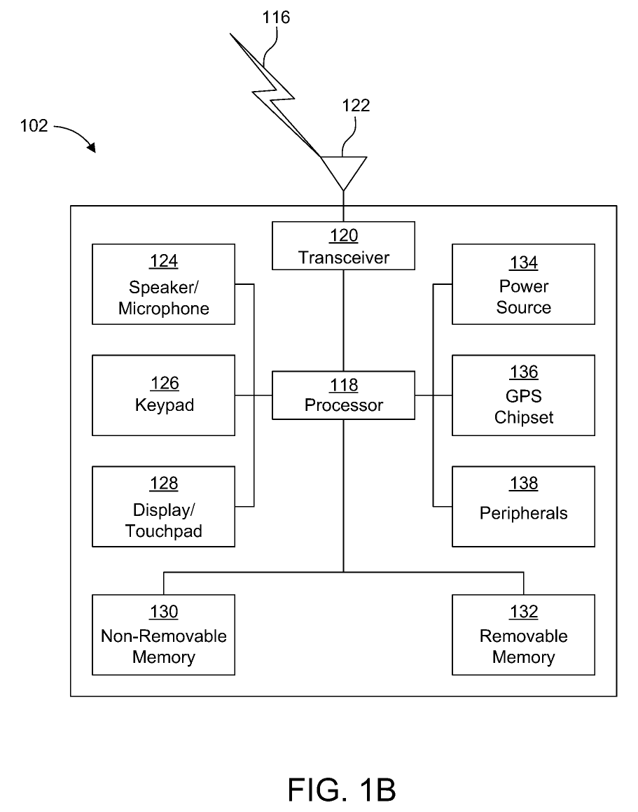

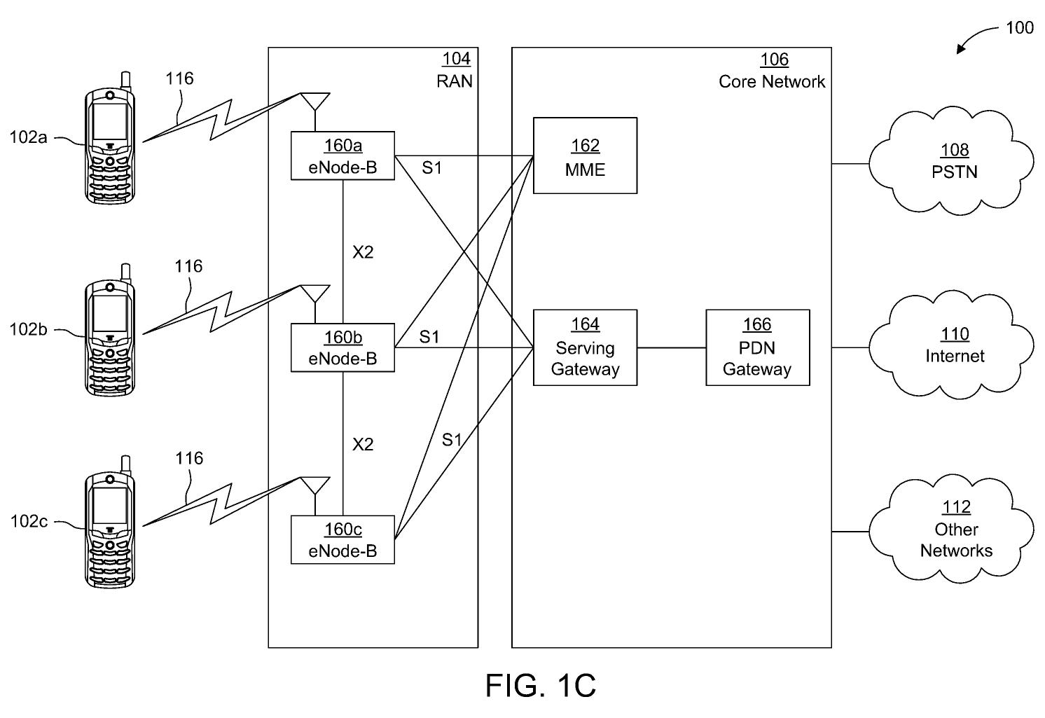

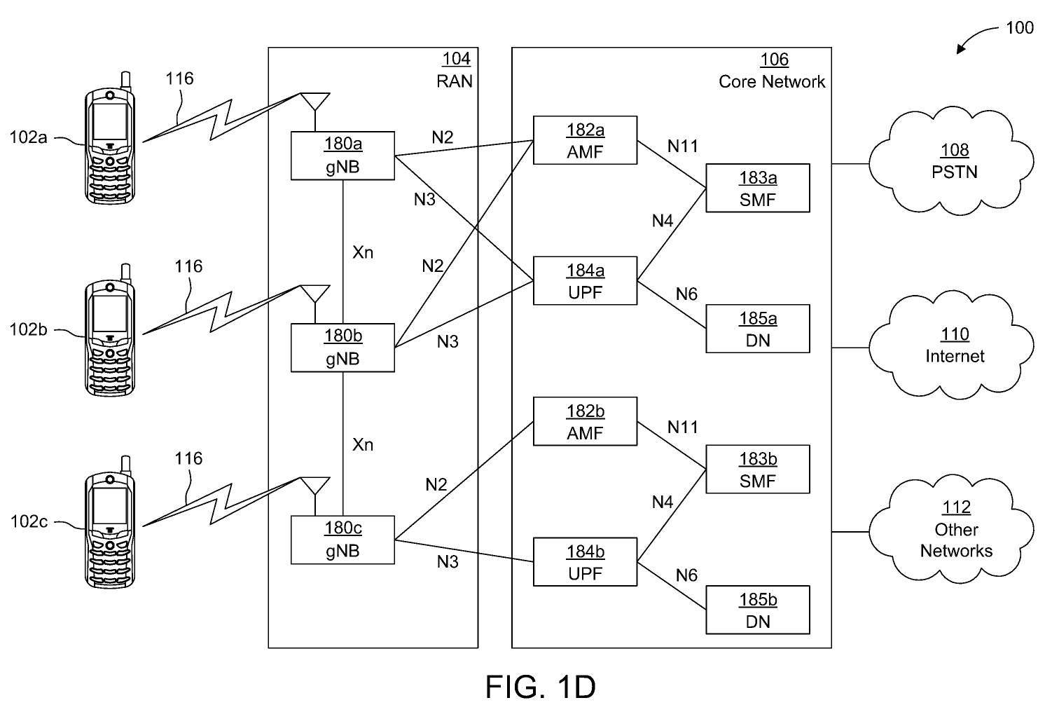

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access , which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102cmay communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180cwithout also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102cwith access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102cmay be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

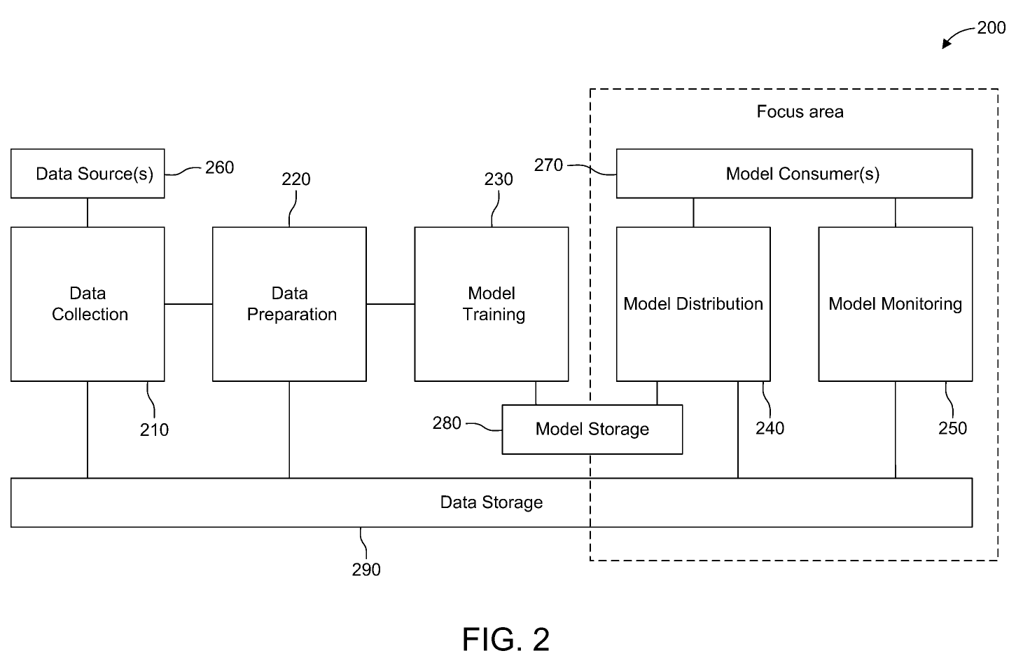

FIG. 2 illustrates a high-level overview of an ML model lifecycle 200. ML model lifecycle 200 may include multiple stages including data collection 210, data preparation 220, model training 230, model distribution 240, which may also include and be referred to as model deployment, and model monitoring 250. A data source 260 may be coupled to data collection 210 to provide sources for data collected in data collection 210, for example. An example of a data source may be application-level data at a WTRU (e.g., an image captured by a camera integrated with WTRU), wireless traffic statistics at the WTRU (e.g., QoS statistics such as packet delay, packet loss ratio, transmitted/received traffic volume in a time window, etc), Such data sources at the WTRU may be consumed by the WTRU (e.g., for training a new model or for inference). Such data sources at the WTRU may also be consumed by a network function (e.g., for training a new model or for inference). Such data sources at the WTRU may also be consumed by a service or an application function (e.g., for training a new model or for inference).A model storage 280 may be coupled to model training 230 and model distribution 240 to enable storage of specific model information via model training 230 and model distribution 240. Model consumers 270 may be coupled to model distribution 240 and model monitoring 250. Model consumers may include WTRUs, network functions, services, and/or application functions. Each of data collection 210, data preparation 220, model training 230, model distribution 240, which may also include and be referred to as model deployment, and model monitoring 250 may be coupled to data storage 290.

In model monitoring 250, the model inference results, such as predictions, for example, may be monitored to evaluate the model’s performance and correctness to determine any degradation. The monitored outputs may be stored in a data repository to facilitate the evaluation of the ML model’s performance and correctness over a period of time or under changing conditions.

ML model performance and correctness can be subdivided into two aspects: ML model performance and correctness evaluation, and ML model performance and correctness monitoring. ML model performance and correctness evaluation may include the evaluation on the model’s accuracy, precision, correctness, and sensitivity, which may be measured via different metrics such as F1 score, AUC-ROC, etc. ML model performance and correctness monitoring may be a framework that, when associated with the ML model use case, may provide a means of automating ML model performance and correctness evaluation.

Ground truth data refers to the accurate factual information collected from direct observation or measurement which is used as a baseline or reference data used to train and/or evaluate models. The terms reference data, labeled data, verified data, true value or data, actual value or data and ground truth data may be used interchangeably. For example, ground truth data may be the correct labels associated with each image in the context of an image classification ML model or may include GPS verified locations of objects in the context of a satellite imaging ML model. The procedures described herein for configuring MPCMI/test vectors may be interpreted as or used for updating the ground truth.

In RAN, the ground truth may be actual signal strength (RSRP/RSRQ), throughput or signal to noise ratio (SNR) measured via WTRU logs. Logs showing that a call was dropped or completed may serve as ground truth data in the context of a call drop prediction ML model. The actual cell that a WTRU moved to following a handover may serve as ground truth data in the context of a handover prediction ML model. GPS coordinates collected from a WTRU may serve as ground truth data in the context of a WTRU location prediction ML model.

Features and functionalities defined by 3GPP to support and assist the management and monitoring of ML models are described including AIML enablement service and NWDAF model management and monitoring. The AIML enablement (AIMLE) service supports ML model management operations including the storage, retrieval and update of ML models. A service consumer, such as a VAL server, for example, may issue a request to an AIMLE server to store, retrieve, or update an ML model. The AIMLE server may further interacts with the ML repository, which stores ML models and corresponding information, to perform the required management operations.

A high-level procedure for ML model performance monitoring is defined. The AIMLE server may detect performance degradation of ML models that are being trained on AIMLE clients. The AIMLE server may receive an ML model performance monitoring subscription request from a VAL server. Based on the request, the AIMLE server monitors the AIMLE clients that are performing training operations on the requested model. The performance degradation detection is based on receiving information from the AIMLE clients. The detailed content of the information received from the AIMLE clients is undefined.

In the core network, ML model management and monitoring functions are defined for the network data analytics function (NWDAF). The model training logical function (MTLF) of the NWDAF supports the training and provisioning of ML models for NWDAF service consumers such as an analytics logic function (AnLF) of the NWDAF, other NWDAF instances with an MTLF, and a location management function (LMF). Moreover, ML models trained by the NWDAF MTLF can be stored in the analytics data repository function (ADRF), which can further be retrieved or removed by the MTLF or by a NF consumer via the MTLF.

The NWDAF MTLF further supports ML model accuracy monitoring. Using this capability, a NWDAF may provide model accuracy information to its consumers. This accuracy is calculated by comparing the predictions generated by the trained model and its corresponding ground truth data.

Currently, the model management and monitoring functions provided by NWDAF apply to ML models that are trained by the NWDAF MTLF.

ML model monitoring may be required to qualitatively measure ML model predictions in variable real-world conditions. ML model monitoring is a feature for detecting ML model performance and correctness drifts. In an AIML framework, evaluating ML model performance and correctness is further complicated by the fact that there are different use cases (e.g., inference, training, HFL, VFL, split operation, etc.) that may require ML model monitoring and by the fact that ML models are abstract to the AIML framework. In other words, the ML models managed in the framework belong to a different domain and cannot therefore be easily evaluated.

Evaluating and/or measuring the performance and correctness of abstract ML models where ground truth data may be abstract. Enabling model evaluation and monitoring for ML models that may be deployed on one or more inferencing nodes can prove difficult. It is therefore required to define solutions for enabling the evaluation and monitoring of abstract ML model in an AIML framework.

ML model performance and correctness evaluation is a technique that may enable the evaluation of performance metrics such as accuracy, precision, sensitivity, root mean square error (RMSE) of deployed ML models.

To effectively evaluate the performance and correctness of an ML model, ground truth data is typically required. This ground truth data may be used to verify that the ML model produces the expected outputs for given inputs. However, to accurately evaluate the performance and correctness of an ML model, this ground truth data must be representative of the input data the model is consuming during real-world operation. Since the distribution and statistical properties of input data as well as the relationships between input data and output data may change over time (i.e., data and model drifts), the ground truth data used to evaluate the performance and correctness of an ML model may need to be updated. Determining if and/or when updates to ground truth data are required such that the performance and correctness of an ML model can be effectively evaluated may not be trivial to determine.

The examples provided herein define the Model Performance and Correctness Monitoring Function (MPCMF). The MPCMF supports capabilities to assist in performing ML model performance and correctness monitoring operations.

It can be appreciated that the MPCMF functionality may be implemented as a standalone service or implemented as an extension to an existing service.

It can be appreciated that an MPCMF may be implemented as a standalone function or service that interfaces to WTRUs and other functions or services such as an AIML enabler server, an ML model repository, and analytics functions. Alternatively, an MPCMF may be realized as an extension to an existing function or service in the system. For example, the MPCMF may be realized as a capability of an AIML enabler service or an ML model repository.

It can also be appreciated that although the MPCMF functional descriptions, procedures, and information flows defined within this paper describe ML model performance and correctness evaluation and monitoring in the context of inference operations, one skilled in the art will recognize that the MPCMF functional entity, procedures, and information flows may also be applicable to evaluating ML model performance and correctness in the context of training operations as well.

A model performance and correctness monitoring function (MPCMF) may provide a service for model evaluation and model monitoring supporting one or more of the following capabilities including MPCMF receiving model performance and correctness monitoring instructions (MPCMI) and test vector sets from an application function (AF), MPCMF preparing and distributing MPCMIs and test vector sets to inference nodes (INs), such as WTRUs, INs performing ML model evaluations using MPCMIs and test vector sets and generating model performance and correctness evaluation reports (MPCERs), and MPCMF collecting MPCERs from INs. The definition of the MPCMF functional entity, procedures, and information flows are hereby provided.

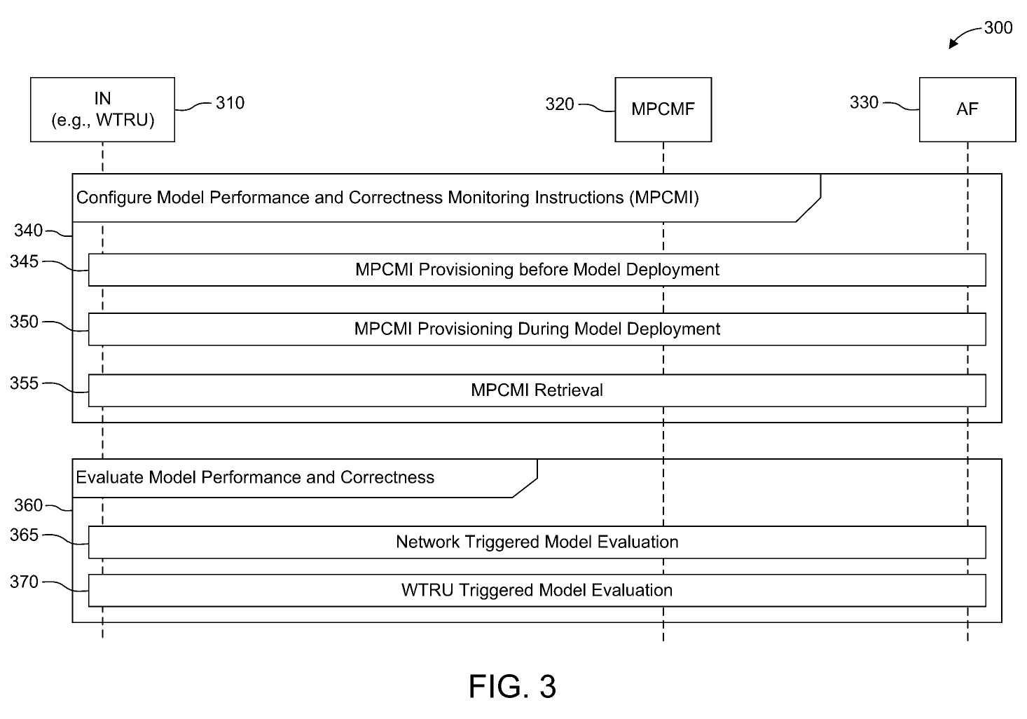

FIG. 3 illustrates a high-level ML model performance and correctness monitoring lifecycle 300. Lifecycle 300 includes an IN 310, which may comprise a WTRU, for example, communicating with an AIMLE server, which may comprise a MPCMF 320, for example, all communicatively coupled to an AF 330.

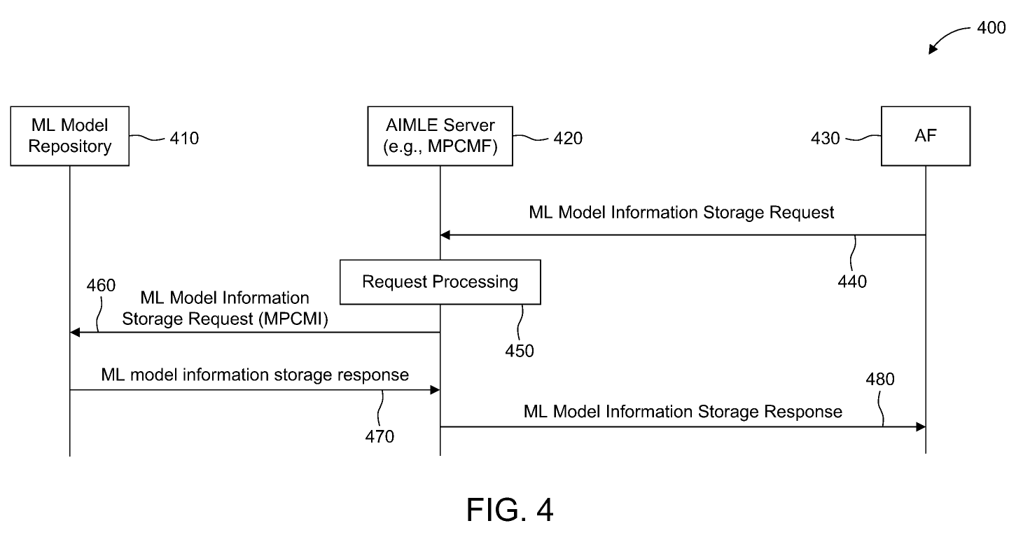

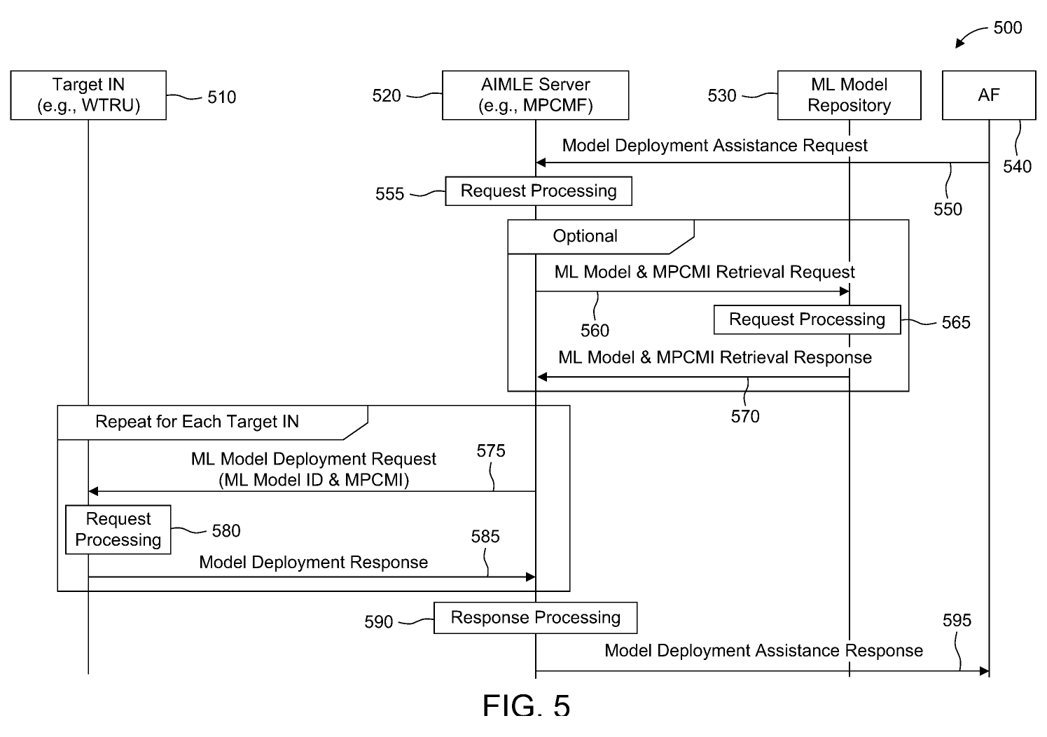

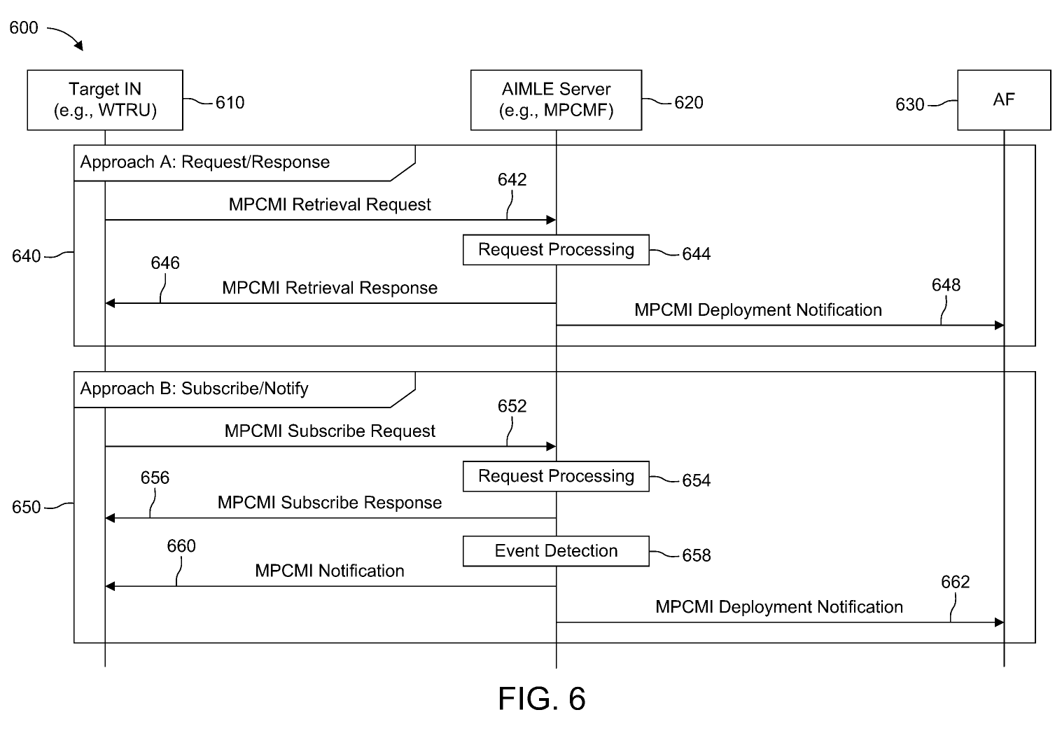

At 340, model performance and correctness monitoring instructions (MPCMIs) are provided to IN 310. The MPCMI may have test vector sets and may be used by IN 310 to monitor model performance and correctness. AF 330 may first provision the MPCMIs to the MPCMF. The MPCMF may then provision the MPCMIs to IN 310 before model deployment 345 or during model deployment 350. Alternatively, IN 310 may retrieve the MPCMIs from MPCMF 320 at 355. IN 310 may be notified by MPCMF 320 of the presence of new MPCMIs via an active subscription. Detailed procedures for 340 are described with respect to FIGS. 4 ,FIG. 5, and FIG. 6.

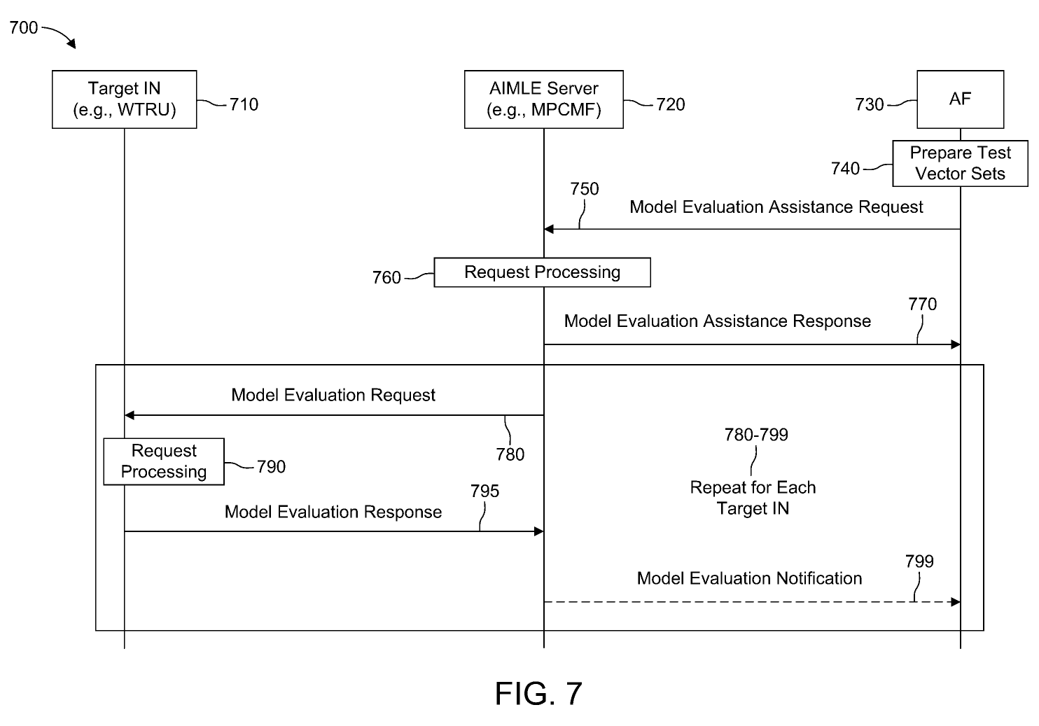

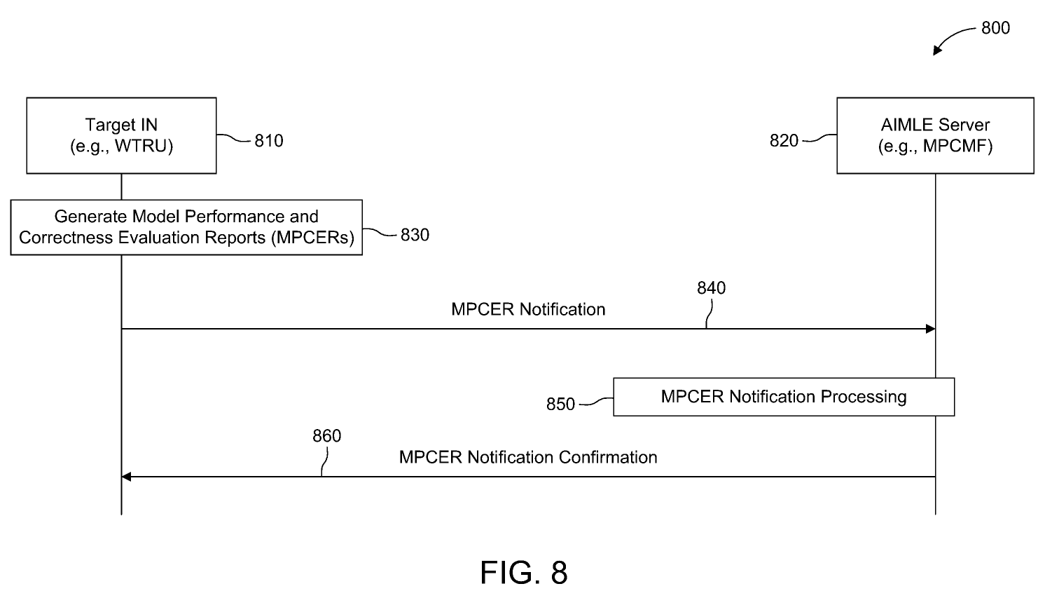

At 360, ML model performance and correctness evaluation is performed by IN 310 using test vectors, based on the configured MPCMIs. MPCMF 320 may then distribute the test vector sets to IN 310 as requested by AF 330. IN 310 may use the test vector sets to evaluate the performance and correctness of an ML model. IN 310 may generate model performance and correctness evaluation reports (MPCERs) and send them to MPCMF 320. MPCMF 320 may forward the MPCERs directly to interested parties such as AFs 330. The ML model performance and correctness evaluation may be performed in a network triggered 365 or a WTRU triggered manner 370. Detailed procedures for 360 are described with respect to FIGS. 7 and FIG. 8.

The following information elements are provided for facilitating ML model performance and correctness monitoring: MPC monitoring instructions (MPCMI), MPC test vectors, MPC evaluation rules, MPC reporting configuration (MPCRC), and MPC evaluation report (MPCER).

It can be appreciated that the information elements described herein may be grouped in different arrangements. For example, the information elements may be grouped and/or associated in a MPCMI, or alternatively, the information elements may be used individually and in any combination (e.g., MPC test vector, MPC evaluation rule, MPC reporting configuration, MPC evaluation report).

The MPCMI provides rules for evaluating the performance of a model (e.g., using test vector sets). The rules may contain metrics and metric-related thresholds (multiple threshold levels for a single metric may be possible) that the model must exceed for acceptable performance. Metrics may include F1 Score and AUC-ROC. The MPCMI may be associated with an ML model. The MPCMI may be provisioned to the MPCMF, such as MPCMF 320, by an AF, such as AF 330. The MPCMF, such as MPCMF 320, may configure the MPCMI to an IN, such as IN 310. Alternatively, an IN, such as IN 310, may retrieve the MPCMI from the MPCMF, such as MPCMF 320. The MPCMI may be stored in an ML repository. The MPCMI may be associated with one or more ML models stored in the ML repository. The MPCMI may be stored and regarded as a part of metadata of a model.

Information that may be included in the MPCMI is described hereafter including an MPCMI identifier that uniquely identifies an MPCMI, an MPCMI creator identifier that uniquely identifies the entity that created an MPCMI, an MPC test vector or test vector set that includes information related to evaluating an ML model, including information about the associated ML model to be evaluated as is further described below, an MPC evaluation rules that include information on how and/or when to perform evaluation of the ML model as is further described below, an MPC reporting configuration that includes information on expected reporting of ML model performance and correctness evaluation reports as is further described below, and an MPCMI scope that may provide the criteria to describe target models and/or INs that an MPCMI may be applied to for evaluating their performance. When the MPCMF receives an MPCMI from an AF. The MPCMF may use the MPCMI scope to determine target models and/or the INs that host the ML models. The MPCMF may use the MPCMI scope to identify corresponding INs and/or ML models, while an IN may use the MPCMI scope to identify ML models. For example, MPCMI scope may comprise the ML model profile identifier and/or ML model identifier of the ML models associated with the MPCMI. The MPCMI scope may also include IN selection criteria that may provide filter conditions for determining applicable INs. Alternatively, this information may be included in an MPC test vector.

It can be appreciated that MPCMI may be implemented as one or more policies. MPCMI policies may be created and/or managed by a Policy Control Function (PCF) in the system. MPCMI policies may be created and/or managed by an AF. An AF may create MPCMI policies via a PCF. A PCF may create and/or manage MPCMI policies for an AF. A PCF may configure, notify, or respond to an MPCMF with MPCMI policies. A PCF may be capable of managing the MPCMI and distributing the MPCMI to WTRUs and/or INs present in the system.

The test vector provides information used to evaluate the performance of ML models. A test vector may include the following information including a unique test vector identifier, test vector inputs, test vector expected outputs, text vector output correlation information, test vector set, test vector set identifier, test vector set address, test vector set creator identifier, test vector set creation time, and ML model profile identifier and/or ML model identifier.

The test vector inputs is information that may be fed to an ML model to generate an inferenced test vector output. The data included in a test vector input may be abstract and in accordance with the ML model supported inputs. For example, the test vector input for generative AI models (e.g., a large language model) may contain instructions and/or additional context information. For example, the test vector input for an image recognition ML model may be a group of images.

The test vector may include one or more expected outputs (e.g., labels or ground truth) indicating expected outputs that should be achieved by inferring the associated test vector input through an associated ML model. The test vector output may be used to compare with the inference output obtained from processing the test vector input through an ML model to derive the performance of the ML model. The test output may be optional (e.g., the MPCMF/AF may not want to disclose the ground truth to an IN when test vector sets are distributed to the IN so that potential privacy/security requirements on the ground truth can be satisfied or enhanced (e.g., the IN cannot cheat on the ground truth)). In this case, the IN may instead return test outputs from the ML model within MPCERs. These test outputs may be evaluated against test vector outputs (e.g., ground truth) maintained at the AF or the MPCMF.

The test vector output correlation information provides information indicating to the system how to correlate the inferred output (e.g., output obtained by processing a test vector input through the ML model) with the test vector expected output. For example, the correlation may indicate that matching the inferred output with the test vector expected output is sufficient (e.g., compare obtained labels with a list of expected labels). For example, the correlation information may indicate that the output should be reported for correlation at the application function.

The test vector set provides a grouping of one or more test vectors that may be used to evaluate the performance of ML models. The test vector set is required for the evaluation of an ML model.

The test vector set identifier uniquely identifies the test vector set. The test vector set identifier identifies a logical grouping of one or more test vectors and may be used to manage the logically grouped vectors. For example, the test vector set identifier may be a hash of all other information included in the test vector set.

The test vector set address may provide address information about a test vector set, through which the test vector set and other information about the test vector set can be retrieved. For example, the test vector set address may be a URL, a URI, an FQDN, or an IP address and a port number.

The test vector set creator identifier uniquely identifies the entity that created a test vector set.

The test vector set creation time provides the time the test vector set was created.

The ML model profile identifier and/or ML model identifier of the ML models associated with the MPCMI. The ML model profile identifier uniquely identifies an ML model profile which includes information associated with an ML model, including an ML model identifier, ML model source, allowed vendors, VAL service identifier(s), ML model phase (e.g., trained, in-training, re-training, etc.), observed performance, etc. Similarly, the ML model identifier uniquely identifies an ML model including the information associated with ML model.

The ML model performance and correctness evaluation rules may provide hyperparameters for model evaluation, order of test vectors, minimum number of test vectors, model evaluation conditions, time window for average model parameters, model performance metrics, and performance and correctness grading information.

The hyperparameters for model evaluation may provide information about inference-specific hyperparameters that should be used when evaluating the performance of ML models using the test vector set. For example, the temperature is a hyperparameter that can be adjusted to control the randomness of a large language model’s output (e.g., tokens) during inference or text generation. For example, k in top-k sampling is a hyperparameter that can be adjusted to control the way (i.e., the balance between randomness and predictability) to select next token or word from the top-k most probable tokens of a large language model’s output. For example, p in top-p sampling is a hyperparameter in top-p sampling where the next token is randomly selected from tokens with top-p cumulative probability. The test vector set may be divided into multiple portions (e.g., 10 test vectors for each portion) and each portion may be assigned with different hyperparameters for model evaluations.

The order of test vectors may provide information about how to use test vectors in order. For example, this information may specify that test vectors included in the test vector set can be randomly selected and used to evaluate the performance of ML models. For example, this information may specify that test vectors included in the test vector set should be used in a certain order (e.g., sequentially as contained in the test vector set), which may be crucial for evaluating a generative AI model especially when test vectors are prepared with certain correlation (e.g., one test vector is a prompt and next test vector is a related or the same prompt with some extra context information).

The minimum number of test vectors may provide information about the minimum number of required test vectors (which could be randomly selected from the test vector set) that should be used to evaluate the performance of a ML model.

The model evaluation conditions may provide information about some evaluation conditions about an IN and/or input data, when to trigger or execute the evaluation. This IE may only be applicable to WTRU triggered model evaluation. Only when such conditions are met, the MPCMI may be triggered to evaluate the performance of the corresponding ML model. Examples of evaluation conditions may include but may not be limited to: the location of the IN, the time window for model evaluation (e.g., one or multiple time windows during which the performance of ML models may be evaluated), immediately triggering MPCMI, periodically triggering MPCMI every certain time interval, input data drift threshold (e.g., the input data drift is deviated from or beyond a range), logits deviation threshold (e.g., logits of potential classes are too different), input data items increased all of sudden, the frequency of input data items within a range, etc.

The time window for average model performance may provide information about a time window for repeatedly calculating the average performance (e.g., model performance metric) of ML models. This time window may not directly or may not only indicate the time but also indicate the number of input data items that are needed to calculate average model performance.

The model performance metrics may provide information about one or multiple model performance metrics (e.g., accuracy, precision, correctness, sensitivity, recall, F1 score, MAE, MSE, RMSE, R2 Score) for supervised learning models that need to be calculated as a part of model evaluation. For unsupervised learning models, the performance metrics may include Silhouette Score, Davies-Bouldin Index, Adjusted Rand Index, Mutual Information, Explained Variance Ratio, Reconstruction Error, cost functions, etc. For generative AI models such as a large language model, the model performance metrics may include Time to First Token (TTFK), Time Per Output Token (TPOT), Bilingual Evaluation Understudy (BLEU), Recall-Oriented Understudy for Gisting Evaluation (ROUGE), Metric for Evaluation of Translation with Explicit Ordering (METEOR), Frechet Inception Distance (FID), Kernel Inception Distance (KID), etc.

The performance and correctness grading information may provide information about how to grade the result of a performance or correctness evaluation of an ML model. For example, the grading information may indicate that an ML model has a 95% accuracy if the ML model evaluation has produced a given output in comparison to the expected reference output and achieved an 80% accuracy if it has produced a different output. In another example, the grading may indicate that an ML model has failed correctness evaluation if it has failed on a single output, from a test vector inputs, or alternatively may indicate that an ML model has passed correctness evaluation if it has failed less than 25% from the test vector inputs. It can be appreciated that the grading information is tightly coupled with the test vector and the ML model objectives, and that grading is defined by the producer of the test vector information.

The model performance and correctness reporting configuration (MPCRC) may provide information about how to generate and share MPCERs. The MPCRC may indicate the report configuration outline, the reporting frequency, the reporting notification address, and the MPCMI expiration time.

The reporting configuration outline may provide information about the selected information or selected parameters to be included in an MPCER. Parameters that may be contained in an MPCER as described herein.

The reporting frequency may provide information about when an MPCER may be generated. For example, an MPCER may be generated after a certain number of test vectors or input data items have been through the ML model. For example, an MPCER may be generated when a model performance metric is within a range (e.g., below a threshold). For example, a MPCER may be generated periodically, especially for online inference. An MPCER may be generated when an IN moves into a region and/or around a location.

The reporting notification address may provide address information that a MPCER should be sent to. For example, the MPCER notification address may be a URL, a URI, an FQDN,or an IP address and a port number.

The MPCMI expiration time may provide information about the time when an MPCMI expires.

The model performance and correctness evaluation report (MPCER) describes model evaluation results for an ML model. Information that may be included in the MPCER is described. The MPCER identifier uniquely identifies an MPCER such that each MPCER generated by an IN has a different and unique identifier. For example, considering a first association of an ML model and a test vector and monitoring instructions, a first MPCER generated by an IN has a first unique MPCER identifier and a second MPCER generated by an IN has a second unique MPCER identifier. The MPCER creator identifier may provide identifier information about the entity that created the MPCER. For example, the MPCER creator identifier may be an identifier of the IN that has evaluated the ML model as denoted by the ML model identifier and generated the MPCER. The MPCMI identifier may provide identity information about the MPCMI, based on which an IN has evaluated a ML model and generated the MPCER. The test vector set identifier may provide identity information about the test vector set, based on which an IN has evaluated a ML model and generated the MPCER. The ML model profile identifier and/or ML model identifier of the ML models associated with the MPCMI. The ML model profile identifier uniquely identifies an ML model profile which includes information associated with the ML model, including an ML model identifier, ML model source, allowed vendors, one or more VAL service identifiers, ML model phase (e.g., trained, in-training, re-training, etc.), observed performance, etc. Similarly, the ML model identifier uniquely identifies an ML model including the information associated with ML model. The hyperparameters used for model evaluation may provide information about inference-specific hyperparameters that have been used for evaluating the performance and correctness of the ML model. The model performance and correctness evaluation outcomes may provide a list of evaluation metrics, outcomes or grading of the ML model evaluation. The list of evaluation metrics may have been specified by the Reporting Configuration outline. For example, the model performance and correctness evaluations may contain a set of triples <test vector identifier, test output, user feedback>, where test output is a one-time output of the ML model using the standard input of a test vector as denoted by test vector identifier; the test output may be logits, normalized logits, and/or the final output of the ML model. The user feedback may be actual feedback about the test output from a user (e.g., a human user or an application). For example, the model performance and correctness evaluations may contain the result averaged over test outputs generated from using all used test vectors.

Model performance and correctness monitoring instructions (MPCMI) can be configured before model deployment, during model deployment, and/or after model deployment. Model deployment here refers to the process of deploying an ML model to inference nodes (INs) for initiating an inference task.

FIG. 4 illustrates a flow diagram 400 for supporting MPCMI provisioning to MPCMF 420 and/or to an ML repository 410. Flow diagram 400 includes a ML model repository 410 communicating with an AIMLE server, which may comprise an MPCMF 420, for example, all communicatively coupled to an AF 430. This flow 400 may occur before ML models are deployed to inference nodes (INs) although the same procedure could be repeated even after the model deployment. Pre-requisites for MPCMI provisioning to MPCMF 420 and ML repository 410 are described hereafter. A first pre-requisite is that AF 430 may have discovered MPCMF 420 or may have been provisioned with the address of MPCMF 420. MPCMF 420 may be integrated within an AIMLE Server. A second pre-requisite is that AF 430 may have generated MPCMIs for one or more ML models. A third pre-requisite is that MPCMF 420 has discovered ML model repository 410 or has been provisioned with ML model repository 410 address.

At 440, AF 430 sends an ML model information storage request to MPCMF 420. This request may contain an AF identifier, AF credentials, an ML model, an ML model metadata and ML Model Performance and Correctness Monitoring Instructions (MPCMI) associated with the ML model. It can be appreciated that the ML model information storage request may contain an ML model identifier and an MPCMI such that the MPCMI is associated with an existing ML model.

At 450, MPCMF 420 may receive and process the ML model information storage request. MPCMF 420 may first authenticate and authorize AF 430 using its identifier and/or its credential. If the authorization is successful, MPCMF 420 may store the ML model and associated MPCMI locally and may determine to store the ML model and MPCMI in an available (e.g., discovered or configured) ML model repository 410. An MPCMF 420 may discover an ML model repository by querying an entity in the system. This query may be based on an ML model repository identifier, ML model identifier, or a location.

At 460, MPCMF 420 may send a request to ML model repository 410 to store the ML model and/or ML model identifier and MPCMI at ML model repository 410.

At 470, ML repository 410 may store the ML model and MPCMI and/or identify a pre-existing ML model using the ML model identifier and associate the MPCMI with the pre-existing ML model (e.g., the identifier of MPCMI may be inserted to the metadata of the pre-existing ML model). ML repository 410 may send an ML model information storage response to MPCMF. This response may contain the request status, the identifier of the ML model, identifier of the associated MPCMI and a failure cause if required.

At 480, MPCMF 420 may send the ML model information storage response to AF 430. This response may contain the request status, the identifier of the ML model, identifier of the associated MPCMI and a failure cause if required.

FIG. 5 illustrates a flow diagram 500 for supporting MPCMI provisioning during model deployment where model deployment and MPCMI provisioning are concurrently performed. Flow diagram 500 includes a target IN, referred to as IN 510, which may comprise a WTRU, for example, communicating with an AIMLE server 520, which may comprise a MPCMF, for example, all communicatively coupled to AF 540. Additionally, an ML model repository 530 is included in communication.

Pre-requisites for MPCMI provisioning during model deployment are described hereafter. A first pre-requisite is that AF 540 may have an ML model and may need to deploy to one or multiple INs. A second pre-requisite is that AF 540 may have discovered AIMLE server 520 or may have been provisioned with the address of AIMLE server 520. AIMLE server 520 may have an integrated MPCMF. In this exemplary scenario, the MPCMF functionality is in AIMLE server 520. A third pre-requisite is that AIMLE server 520 may have discovered the ML repository or may have been provisioned with the address of the ML repository. A fourth pre-requisite is that the ML repository may have been provisioned with MPCMIs.

Steps for the procedure of MPCMI provisioning during model deployment are described hereafter.

At 550, AF 540 may send a model deployment assistance request to AIMLE server 520. This request may contain an ML model identifier to be deployed to INs, the identifier of IN(s), MPCMI identifier, the identifier and the credential of AF 540, etc.

As an alternative, the model deployment assistance request may be a subscription request. The subscription request may contain notifications settings. Notification settings may include an endpoint address to send notifications to. Notification settings may also include time based and/or event-based settings for sending notifications. Time based events may include absolute time or periodic time. Events based may include selection of INs for model deployment, sending of model deployment requests to INs, reception of model deployment responses, aggregation of a certain number of responses, or upon completion of all responses.

At 555, AIMLE server 520 receives the request of 550. AIMLE server 520 may first authorize the request, e.g., based on the identifier and the credential of AF 540. If the authorization is successful, AIMLE server 520 may discover and select INs for AF 540 according to the information contained in the MPCMI scope. AIMLE server 520 may determine to retrieve the ML model, MPCMIs, and ML members information from the ML repository if the MPCMI is not available locally using the ML model identifier and MPCMI identifier.

At 560, AIMLE server 520 may send an ML model and MPCMI retrieval request to the ML repository. This request may contain the identifier(s) of ML model and MPCMI(s), the identifier of AF 540, the identifier of INs. This request may also contain the identifier and the credential of AIMLE server 520. It can be appreciated that an MPCMI may be associated with an ML model and that retrieving the ML model may indicate to ML model repository 530 that the associated MPCMI needs to be retrieved as well.

At 565, ML repository 530 may first authenticate and authorize the request, e.g., based on the identifier and the credential of AIMLE server 520. The ML Repository may use the ML model identifier and MPCMI identifier, the identifier of AF 540, the identifier of INs to determine ML models and associated MPCMIs.

It can be appreciated that MPCMIs may be associated with an ML model and that retrieving the ML model may indicate to ML model repository 530 that the associated MPCMIs need to be retrieved as well.

It can be appreciated that an MPCMI may be retrieved from ML model repository 530 by providing an MPCMI identifier or by retrieving an ML model or ML members information that may be associated with an MPCMI.

At 570, ML repository 530 may send a response to AIMLE server 520. This response may contain the MPCMI retrieval request status along with associated ML model, MPCMIs, and/or ML member information.

575-585 may be repeated for each IN indicated at 550 and/or determined at 555.

575, AIMLE server 520 may send a model deployment request to every IN that has been indicated at 550 and/or discovered/selected at 555. This request may contain the ML model, ML model identifier and/or MPCMI and/or MPCMI identifier. This request may also contain the identifier and the credential of AIMLE server 520 and/or the identifier and the credential of AF 540.

It can be appreciated that the ML model, ML model identifier and/or MPCMI may contain a URL for which the associate ML model and MPCMIs may be retrieved from.

At 580, IN 510 receives the model deployment request. IN 510 may first authenticate and authorize the request, e.g., based on the identifier and the credential of AIMLE server 520 and/or the identifier and the credential of AF 540. IN 510 may retrieve the indicated ML model (e.g. from the specified URL) or may start using the ML model if included in the request. If an MPCMI was obtained with the ML model, IN 510 may start to perform inferencing and perform model performance and correctness evaluation based on the MPCMI. For example, IN 510 may use the test vector and the evaluation rules included in the MPCMI to evaluate the performance and correctness of the ML model used for inference. IN 510 may start reporting the evaluation information in accordance with the reporting configuration included in the MPCMI. As an alternative and not shown on FIG. 5, IN 510 may retrieve the MPCMIs separately for the ML model as described in FIG. 6.

At 585, IN 510 may send a model deployment response to AIMLE server 520 to confirm deployment of the ML model. This response may contain the model deployment request status as determined at 580. The response may additionally include information indicating if the ML model evaluation information (e.g., test vector, evaluation rules and reporting) is accepted, and may include a baseline evaluation (e.g., a first evaluation) of the received model. The baseline evaluation may be useful to establish the baseline performance of the ML model.

At 590, AIMLE server 520 receives the model deployment response from one or more INs. If AIMLE server 520 deploys an ML model to multiple INs, AIMLE server 520 may track the ML model deployment progress by aggregating ML model deployment responses from multiple INs.

At 595, AIMLE server 520 may send an ML model deployment assistance response to AF 540. The response may include aggregated ML model deployment responses from multiple INs. For example, the response may indicate the identifier of INs that have, and/or have not successfully installed the ML model and may include for each IN the baseline evaluation of the provided ML model.

As an alternative, one or more notifications may be sent if the request at 550 is a subscription request. Notifications may be sent according to the notification settings provided in the subscription request.

The ML model deployment and MPCMI deployment may be performed synchronously as described in FIG. 5. In other words, the deployment assistance request may deploy the ML model and MPCMI simultaneously to the WTRU. It can alternatively be appreciated that the deployment assistance request may be used to deploy the ML model and MPCMI asynchronously; for example, the procedure described in FIG. 5 may be performed a first time for deploying ML model(s) (e.g., deploy ML models only) to one or more INs, and may be performed a second time for deploying MPCMI (e.g., deploy MPCMI only) associated with the deployed ML models to one or more INs. It can further be appreciated that the deployment of MPCMI may be performed by the PCF in systems where the MPCMI is a policy and policies are deployed to WTRUs via the PCF.

FIG. 6 illustrates a flow diagram 600 for supporting IN(s) obtaining MPCMIs from MPCMF 620. Flow diagram 600 includes a target IN, referred to as IN 610, which may comprise a WTRU, for example, communicating with an AIMLE server, which may comprise a MPCMF 620, for example, all communicatively coupled to AF 630. Pre-requisites for IN 610 to obtain MPCMIs from MPCMF 620 are described hereafter. A first pre-requisite is that one or more MPCMIs have been provisioned to MPCMF 620 and/or ML model repository. A second pre-requisite is that IN 610 may have discovered MPCMF 620 or may have been provisioned with the address of MPCMF 620. MPCMF 620 may be integrated within an AIMLE Server. A third pre-requisite is that an AF may have subscriptions to receive notifications for access to ML models and/or MPCMIs.

Steps for the procedure of IN obtaining MPCMIs from MPCMF 620 are described hereafter.

At 640 there is a request/response-based approach. At 642, IN 610 may send an MPCMI retrieval request to MPCMF 620. This request may contain the identifier and the credential of IN 610 and MPCMI filters. The MPCMI filters may include the identifier of an MPCMI, the identifier of an ML model, the identifier (e.g., identifier, name, type) of an application (e.g., VAL Client and/or AIMLE Client present on IN 610) requiring an ML model. This request may contain filter information about one or more MPCMIs and/or ML models and/or applications.

It can be appreciated that the message at 642 may be a request to retrieve an ML model. The request may include an ML model identifier and an indication that the MPCMI and/or test vectors are requested along with the ML model. Alternatively, MPCMF 620 may be configured to determine if an MPCMI and/or test vectors are associated with a requested ML model.

At 644, MPCMF 620 receives the MPCMI retrieval request. MPCMF 620 may first authenticate and authorize the request, e.g., based on the identifier and the credential of IN 610. MPCMF 620 may use the information present in the request (e.g., information about MPCMIs and/or ML models and/or applications, etc.) to identify matching MPCMIs. A matching MPCMI may be an MPCMI identified via the MPCMI identifier, identified via an association with an ML model and/or identified via an association with an application requiring an ML model. Note that MPCMF 620 may retrieve identified ML models and/or MPCMIs from an ML repository, which is not shown in FIG. 6.

Not shown on FIG. 6, if MPCMF 620 does not identify a matching MPCMIs, MPCMF 620 may attempt to retrieve the MPCMI from an ML Repository by providing information about MPCMIs and/or ML models and/or applications requiring an ML model (e.g., information received at 642).

It can be appreciated that the processing at 644 may be for identifying an ML model and MPCMF 620 may identify an MPCMI associated with a requested ML model (e.g., based on the request or on configuration).

At 646, MPCMF 620 may send an MPCMI retrieval response to IN 610. This response may contain the MPCMI, an indication whether an MPCMI was successfully identified or retrieved from the ML model repository, and the identifier and/or the content of the identified MPCMIs.

It can be appreciated that the message at 646 may be for returning an ML model, such as when the ML model content of 642 was for retrieving an ML model. If MPCMF 620 has identified an ML model, the response may include an identified MPCMI associated with a requested ML model.

At 648, MPCMF 620 may send an MPCMI deployment notification to AF 630 (e.g., AF 630 that originally provisioned the matching MPCMIs and/or ML model associated with a MPCMI to MPCMF 620). This notification may contain information about MPCMIs, the ML models, the applications, and/or the identifier of IN 610.

It can be appreciated that the message at 648 may be for notifying about a retrieved ML model and may include information about an MPCMI associated with the ML model provided to an IN at 646.

At 650 is illustrated a subscribe/notify-based approach. At 652, IN 610 may send an MPCMI subscribe request to MPCMF 620. This subscription request may contain the identifier and the credential of IN 610, a notification endpoint for notifying IN 610 and MPCMI filters. The MPCMI filters may include the identifier of an MPCMI, the identifier of an ML model, and/or the identifier (e.g., identifier, name, type) of an application (e.g., VAL Client and/or AIMLE Client present on IN 610) requiring an ML model. The MPCMI filters may contain notification conditions that trigger to send the MPCMI notification 660. For example, a MPCMI notification condition may indicate that a MPCMI for a particular ML model has been created or updated (e.g., by MPCMF 620, by an AF, by an administration application) or expired. This request may contain filter information about one or more MPCMIs, ML models, and/or applications.

It can be appreciated that the message at 652 may be a request to subscribe to obtain ML models. The request may include an indication that the MPCMI is requested along with the ML model and/or alternatively, MPCMF 620 may be configured to determine if an MPCMI is associated with a subscribed ML model.

At 654, MPCMF 620 receives the MPCMI subscription request. MPCMF 620 may first authenticate and authorize the request, e.g., based on the identifier and the credential of IN 610. MPCMF 620 may create a subscription considering the MPCMI filters for the subscribing IN.

Additionally, MPCMF 620 may identify matching MPCMIs as described at 644 of FIG. 6.

It can be appreciated that the processing at 654 may be for subscribing to ML model updates and MPCMF 620 may identify an MPCMI associated with a subscribed ML model (e.g., based on the request or on configuration).

At 656, MPCMF 620 may send an MPCMI subscription response to IN 610. The subscription response may include a subscription identifier that IN 610 may use to manage (e.g., update, delete) the subscription, an indication whether an MPCMF has successfully created the subscription. If MPCMF 620 has successfully identified MPCMI or retrieved MPCMI from the ML model repository, the response may include the MPCMI identifier(s) and/or the content of the identified MPCMIs.

It can be appreciated that the message at 656 may be for returning an ML model subscription identifier. If MPCMF 620 has identified an ML model, the response may include identified MPCMIs associated with an identified ML model.

At 658, MPCMF 620 may detect an MPCMI related event matching an “MPCMI Filter” and/or an MPCMI notification condition. For example, an MPCMI related event may be that a MPCMI has been created or updated (e.g., by MPCMF 620, by an AF, by an administration application) or expired.

It can be appreciated that the processing 658 may be for detecting events associated with ML model updates and MPCMF 620 may identify an MPCMI associated with an ML model event (e.g., based on the request or on configuration). For example, an ML model related event may be that a ML model has been created or updated or deleted, and MPCMF 620 may include information about MPCMIs associated with the ML model in a notification about the ML model event.

At 660, MPCMF 620 may send an MPCMI notification to IN 610 using the notification endpoint of IN 610. This notification may contain the content of MPCMIs associated with the event detection.

It can be appreciated that the message at 660 may be for notifying about ML model updates. If MPCMF 620 has detected an ML model update, the response may include an identified MPCMI associated with an updated ML model.

At 662, MPCMF 620 may send an MPCMI deployment notification to AF 630 (e.g., AF 630 that originally provisioned or updated the MPCMIs to MPCMF 620). This notification may contain information about MPCMIs, ML models, applications, and/or the identifier of IN 610.

It can be appreciated that the message at 662 may be for notifying about ML model updates to IN 610 and may include information about an MPCMI associated with the ML model update provided to IN 610 at 660.

ML model performance and correctness evaluation involving the use of test vectors can be performed in a network triggered or WTRU triggered manner as illustrated in FIGS. 7 and FIG. 8 respectfully.

FIG. 7 illustrates a flow diagram 700 of a network triggered model performance and correctness evaluation procedure. Flow diagram 700 includes a target IN, referred to as IN 710, which may comprise a WTRU, for example, communicating with an AIMLE server, which may comprise a MPCMF 720, for example, all communicatively coupled to AF 730. Pre-requisites for the network triggered ML model evaluation procedure are described hereafter. The first pre-requisite is that the ML model has been deployed to one or multiple INs. A second pre-requisite is that AF 730 may have discovered MPCMF 720 or may have been provisioned with the address of MPCMF 720. MPCMF 720 may be integrated within an AIMLE Server.

Steps for the procedure network triggered ML model evaluation are described hereafter.

At 740, AF 730 may prepare one or multiple test vector sets for an ML model. For example, AF 730 may use application-level knowledge to form test vectors associated with an ML model. Not shown on FIG. 7, AF 730 may have pre-provisioned the test vectors to the ML model repository via MPCMF 720 and may have obtained identifiers associated with the test vectors provisioned with MPCMF 720 and/or ML model repository. It can be appreciated that the test vectors may be included in an MPCMI and that the MPCMI may have been provisioned with MPCMF 720 and/or ML model repository. The MPCMI may also be associated with an ML model. The content of test vectors is described herein.

At 750, AF 730 may send a model performance and correctness evaluation assistance request to MPCMF 720. This request may contain one or more of an ML model identifier, a test vector, an identifier of a test vector, an address to retrieve a test vector, an identifier of an MPCMI associated with an ML model. The identifier of an ML model may be included in an MPCMI or included separately in this request. This request may also indicate the identifier of one or more INs, which otherwise may have been included in an MPCMI. As an alternative to a list of INs, the request may include IN selection criteria, e.g. as found in MPCMI scope. This request may also contain the identifier and the credential of AF 730. AF 730 may provide a notification endpoint to be notified about obtained MPCER obtained from the ML model performance and correctness evaluation.

At 760, MPCMF 720 receives the model performance and correctness evaluation assistance request. MPCMF 720 may first authorize the request, e.g., based on the identifier and the credential of AF 730. If the authorization is successful, MPCMF 720 may identify and determine IN(s), and the ML model(s) based on the information contained in the MPCMI.

MPCMF 720 may determine based on the request whether the test vector(s) and/or MPCMI are available locally or whether to retrieve the test vectors and/or MPCMI from the ML model repository. If it is determined the test vector(s) and/or MPCMI are in the ML repository, MPCMF 720 may retrieve the test vector(s) and/or MPCMI from the ML repository. Note this retrieval is not shown in the figure.

At 770, MPCMF 720 may send a model performance and correctness evaluation assistance response to AF 730. This response may contain an indication whether the request for model evaluation was successfully received and handled. If IN selection criteria were provided in the request, MPCMF 720 may also return the list of INs selected for model evaluation.

It can be appreciated that in some systems, the model performance and correctness evaluation assistance response may be sent to AF 730 after the ML model evaluation is completed (e.g., after 795 of FIG. 7) and may be sent as an alternative to the message described in step 8 of FIG. 7 and may include the evaluation results as described at 799 of FIG. 7.

Each of 780-799 may be executed for one or more IN.

At 780, MPCMF 720 may send a model performance and correctness evaluation request to a determined IN (e.g., at 760) illustrated as IN 710. This request may contain information elements such as but not limited to the identifier and credential of MPCMF 720, the identifier and credential of AF 730, the test vector sets and/or MPCMI. This request may also contain a model performance and correctness monitoring report (MPCER) notification address, which can be used to send MPCER notifications. MPCMF 720 may also indicate a MPCER report identifier that is associated with AF 730 and the request received from AF 730. It can be appreciated that the MPCER may be provided back to AF 730 if AF 730 has indicated a means for MPCMF 720 to notify AF 730 about MPCER (as illustrated at 799). The request may include the test vector and/or MPCMI and/or information for retrieving the test vector and/or MPCMI from MPCMF 720 or from other entities.

At 790, IN 710 receives the model performance and correctness evaluation request. IN 710 may authenticate and authorize the request, e.g., based on the identifier and the credential of MPCMF 720 and/or the identifier and the credential of AF 730. If the authentication is successful, the IN may store the received test vector and/or MPCMI or alternatively may retrieve the test vector and/or MPCMI from MPCMF 720. IN 710 may feed the test vector inputs to an associated ML model and may obtain corresponding ML model test outputs. IN 710 may compare the obtained ML model test outputs with the test vector expected outputs considering the evaluation rules described herein. IN 710 may determine a performance and correctness result that is associated with the ML model and test vector used. IN 710 may capture the performance and correctness evaluation results in an MPCER as described herein.

At 795, IN 710 may send a model performance and correctness evaluation response to MPCMF 720. This response may contain the model performance and correctness evaluation MPCER and may additionally include the identifier of the MPCER (e.g., as provided at 780), the identifier of IN 710, the identifier of the ML model, the time of the evaluation and additional data such as the location of the WTRU when the evaluation was performed. If the request included a notification endpoint and a schedule for executing the ML model performance and correctness evaluation, or the request included an MPCMI that included a schedule for executing the ML model performance and correctness evaluation, IN 710 may repeat the evaluation accordingly and may notify MPCMF 720 according to the evaluation schedule.

At 799, a model evaluation notification may be sent to AF 730 if AF 730 has indicated a means for MPCMF 720 to notify AF 730 about MPCER. This notification may include the MPCER, MPCER identifier, the test vector, MPCMI, MPCMI identifier and/or information received from IN 710 at 795.

It can be appreciated that the message sent at 799 of FIG. 7 may alternatively be a ML model evaluation assistance response as described at 770 of FIG. 7 and may be sent as a response to the message received at 750 of FIG. 7.

FIG. 8 illustrates a flow diagram 800 for supporting the ML model evaluation triggered by the WTRU. Flow diagram 800 includes a target IN 810 that may comprise a WTRU, for example, in communication with an AIMLE server that may comprise a MPCMF 820, for example. A first pre-requisite is that the ML model and associated MPCMIs and/or test vectors have been deployed or retrieved by one or more INs. As a second pre-requisite, the MPCMF may be integrated within an AIMLE Server.

At 830, target IN 810 may conduct model performance and correctness evaluation for an ML model and generate one or more MPCERs according to MPCMI associated with the ML model. The MPCERs may be generated by using information included in the MPCMI, such as the test vectors, the evaluation rules, the reporting configuration and the evaluation report to generate MPCER.

In a first example, target IN 810 may use information from the MPCMI, such as a test vector and evaluation rules to evaluate an ML model. Target IN 810 may perform the evaluation based on evaluation rules and may capture the ML model evaluation in a MPCER according to the MPCMI and/or the MPCMI reporting configuration. Target IN 810 may communicate the MPCER to MPCMF 820 and/or with a provided endpoint (e.g., AF) as required in the reporting configuration.

At 840, target IN 810 may send a MPCER notification to MPCMF 820, if the MPCER notification address in the MPCMI has been set to the address of MPCMF 820. This notification may contain the MPCERs generated at 830. This notification may also contain the identifier and the credential of target IN 810.

At 850, MPCMF 820 may first authenticate and authorize the request, e.g., based on the identifier and the credential of target IN 810. If the authentication is successful, MPCMF 820 may accept and store the MPCERs and may further notify an AF that has subscribed to receive MPCERs for a given ML model or IN.

At 860, MPCMF 820 may return a MPCER notification confirmation with an appropriate status.

Although not shown in FIG. 8 it can be appreciated that a model evaluation notification may be sent to the AF if the AF has indicated a means for MPCMF 820 to notify the AF about MPCER. This notification may include the MPCER, MPCER identifier, the test vector, MPCMI, MPCMI identifier and/or information received from target IN 810 at 840.

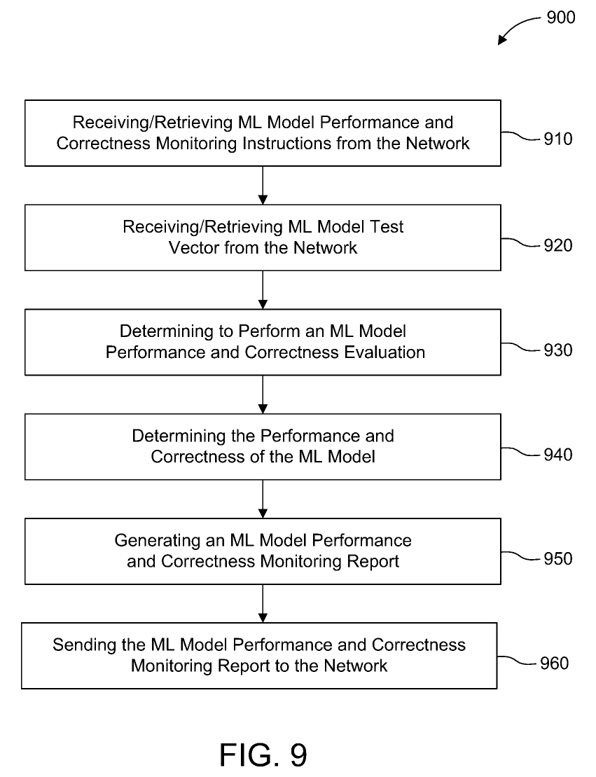

FIG. 9 illustrates a method 900 for model performance and correctness monitoring for terminal devices. At 910, method 900 includes the WTRU acquiring ML model performance and correctness monitoring instructions (MPCMI) from the network at 910. In an example, this acquiring at 910 may include the WTRU receiving MPCMI within a received ML model information storage request from the network (460, FIG. 4), the WTRU may receive MPCMI within a received ML model deployment request from the network (575, FIG. 5), the WTRU may retrieve MPCMI from the network (642, FIG. 6) and receive MPCMI in a response (646, FIG. 6), and/or the WTRU may subscribe to the network (652, FIG. 6) and receives MPCMI in a notification (660, FIG. 6).

At 920, method 900 includes the WTRU acquiring ML model test vectors from the network. For example, the WTRU may receive ML model test vectors embedded within an MPCMI (test vector set defined herein) and/or the WTRU may retrieves ML model test vectors from the network using a ML model identifier or test vector set address provided in an MPCMI (described herein).

At 930, method 900 includes the WTRU determining to perform an ML model performance and correctness evaluation. For example, the WTRU may receive a request from an AIMLE Server (780, FIG. 7) to trigger an ML model performance and correctness evaluation. In an example, the WTRU may trigger an ML model performance and correctness evaluation (830, FIG. 8).

At 940, method 900, based on the ML model test vectors, includes the WTRU determining the performance and correctness of the ML model. For example, the WTRU may evaluate the AI model using the test vectors (790, FIG. 7). In an example, the WTRU may determine the performance and correctness of the ML model by feeding test vector inputs into ML model and comparing inference outputs of the ML model to test vector outputs (described herein).

At 950, method 900 includes the WTRU generating an ML model performance and correctness monitoring report (MPCER) comprising the determined performance and correctness of the ML model and sends this information to the network (795, FIG. 7 or 840, FIG. 8).

At 960, method 900 includes the WTRU sending the ML model performance and correctness monitoring report to the network.

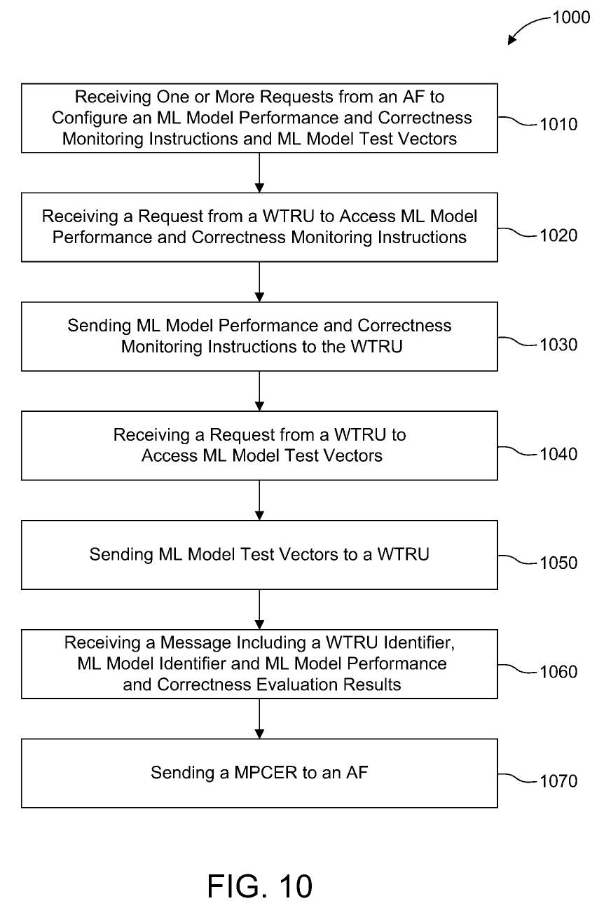

FIG. 10 illustrates a method 1000 for model performance and correctness monitoring for network service. A service in the network (e.g., AIMLE Server with MPCMF) may perform the actions of method 1000. At 1010, method 1000 may include the service receiving one or more requests from an AF to configure an ML model performance and correctness monitoring instructions (MPCMI) and ML model test vectors (440, FIG. 4). For example, the service may receive ML model test vectors which may be embedded within an MPCMI (test vector set defined herein).

At 1020, method 1000 may include the service receiving a request from a WTRU to access ML model performance and correctness monitoring instructions (MPCMI). For example, the request from the WTRU may be a retrieve request (642, FIG. 6). In an example, the request from the WTRU may be a subscribe request (652, FIG. 6).

At 1030, method 1000 includes the service sending ML model performance and correctness monitoring instructions (MPCMI) to the WTRU. For example, the service may send MPCMI to the WTRU in an ML model information storage request (460, FIG. 4). In an example, the service may send MPCMI to the WTRU in an ML model deployment request (575, FIG. 5). In an example, the service may send MPCMI to the WTRU in a retrieve response (646, FIG. 6). In an example, the service may send MPCMI to the WTRU in a notification (660, FIG. 6).

At 1040, method 1000 includes the service receiving a request from a WTRU to access ML model test vectors. For example, the request from the WTRU may be a retrieve request for ML model test vectors (described herein). In an example, the request from the WTRU may be an MPCMI retrieve request (642, FIG. 6) or MPCMI subscribe request (652, FIG. 6), wherein the MPCMI comprises ML model test vectors (described herein).

At 1050, method 1000 includes the service sending ML model test vectors to the WTRU. For example, the service may send ML model test vectors to the WTRU within an ML model information storage request (460, FIG. 4). In an example, the service may send ML model test vectors to the WTRU within an ML model deployment request (575, FIG. 5). In an example, the service may send AIML test vectors to the WTRU in an ML model test vector retrieve response (described herein). In an example, the service may send AIML test vectors to the WTRU in an MPCMI retrieve response (646, FIG. 6) or MPCMI notification (660, FIG. 6), wherein the MPCMI comprises ML model test vectors (described herein).

At 1060, method 1000 includes the service receiving a message including a WTRU identifier, ML model identifier and ML model performance and correctness evaluation results (MPCER). In an example, the service may receive MPCER information in an MPCER retrieve response from the WTRU (795, FIG. 7). Inn an example, the service may receive MPCER information in an MPCER notification from the WTRU (840, FIG. 8).

At 1070, method 1000 includes the service sending a MPCER to an AF.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for model performance and correctness monitoring for terminal devices, the method comprising:
acquiring, by a wireless transmit and receive unit (WTRU), instructions for machine learning (ML) model performance and correctness monitoring from a network;
acquiring, by the WTRU, ML model test vectors from the network;
determining, by the WTRU, to perform an ML model performance and correctness evaluation;
determining, by the WTRU, based on the ML model test vectors, a performance and correctness of the ML model;
generating, by the WTRU, a report for a ML model performance and correctness monitoring according to the acquired instructions; and
sending the generated report to the network.

2. The method of claim 1, wherein the acquired instructions includes at least one of an identifier for an MPCMI, a creator identifier, one or more test vectors, a test vector set identifier, a test vector set address, one or more model performance and correctness evaluation rule, a reporting configuration, and MPCMI scope, wherein MPCMI scope comprises of ML model profile identifier, ML model identifier, and inference node (IN) selection criteria.

3. The method of claim 1, wherein the report comprises of one or more of a MPCER identifier, a creator identifier, an MPCMI identifier, a test vector set identifier, a ML model profile identifier, a ML model identifier, hyperparameters used for model evaluation, and model performance and correctness evaluation outcomes, wherein model performance and correctness evaluation outcomes comprises one or more of a test vector identifier, a test output, and user feedback.

4. The method of claim 1, wherein the acquiring instructions includes at least one of the WTRU receiving MPCMI within a received ML model retrieval response from the network, receiving MPCMI within a received ML model deployment request from the network, the WTRU retrieving MPCMI from the network, or the WTRU subscribing to the network and receiving MPCMI in a notification.

5. The method of claim 1, wherein the acquiring ML model test vectors includes at least one of receiving ML model test vectors embedded within an MPCMI or retrieving ML model test vectors from the network using a ML model identifier or test vector set address provided in an MPCMI.

6. The method of claim 1, wherein the determining to perform an ML model performance and correctness evaluation includes at least one of receiving a request from an artificial intelligence machine learning (AIMLE) server to trigger an ML model performance and correctness evaluation or triggering an ML model performance and correctness evaluation based on an MPCMI.

7. The method of claim 1, wherein the determining the performance and correctness of the ML model includes the WTRU providing model test vectors into the ML model and generating model inference outputs.

8. The method of claim 7, wherein the determining the performance and correctness of the ML model includes the WTRU determining ML model performance metrics by comparing inference outputs of the ML model to test vector outputs, wherein the ML model performance metric comprise one or more of accuracy, precision, correctness, sensitivity, recall, F1 score, mean absolute error, mean square error, root mean square error, and R2 score.

9. A method for model performance and correctness monitoring for network service, the method comprising:
receiving one or more requests from an AF to configure instructions for a ML model performance and correctness monitoring and ML model test vectors;
sending the instructions to a wireless transmit and receive unit (WTRU);
sending ML model test vectors to the WTRU;
receiving a message including a WTRU identifier, ML model identifier and ML model performance and correctness evaluation results (MPCER); and
sending a MPCER to an AF.

10. The method of claim 9, further comprising receiving a request from a WTRU to access at least one of ML model performance and correctness monitoring instructions (MPCMI) and ML model test vectors.

11. The method of claim 10, wherein receiving a request from a WTRU to access MPCMI includes at least one of a retrieve request or a subscribe request.

12. The method of claim 9, wherein the receiving one or more requests from an AF includes receiving ML model test vectors which may be embedded within an MPCMI.

13. The method of claim 9, wherein the instructions include an identifier for the MPCMI, a creator identifier, one or more test vectors, a test vector set identifier, test vector set address, one or more model performance and correctness evaluation rule, a reporting configuration, and MPCMI scope, wherein MPCMI scope comprises of ML model profile identifier, ML model identifier, and inference node (IN) selection criteria.

14. The method of claim 9, wherein the sending the instructions includes sending MPCMI to the WTRU in at least one of an ML model retrieval response, an ML model deployment request, a retrieve response, or a notification.

15. The method of claim 9, wherein the MPCER comprises of one or more of a MPCER identifier, a creator identifier, an MPCMI identifier, a test vector set identifier, a ML model profile identifier, a ML model identifier, hyperparameters used for model evaluation, and model performance and correctness evaluation outcomes, wherein model performance and correctness evaluation outcomes comprises one or more of a test vector identifier, a test output, and user feedback.

16. The method of claim 9, wherein the receiving a request from a WTRU to access ML model test vectors includes at least one of a retrieve request for ML model test vectors, an MPCMI retrieve request, or an MPCMI subscribe request, wherein the MPCMI comprises ML model test vectors.

17. The method of claim 9, wherein the sending ML model test vectors to the WTRU includes sending ML model test vectors to the WTRU within at least one of an ML model retrieval response, an ML model deployment request, an ML model test vector retrieve response, an MPCMI retrieve response, wherein the MPCMI comprises ML model test vectors.

18. The method of claim 9, wherein the sending ML model test vectors to the WTRU includes at least one of sending ML model test vectors to the WTRU within an ML model deployment request, sending AIML test vectors to the WTRU in an ML model test vector retrieve response, or sending AIML test vectors to the WTRU in an MPCMI retrieve response, wherein the MPCMI comprises ML model test vectors.

19. The method of claim 9, wherein the sending ML model test vectors to the WTRU includes sending ML model test vectors to the WTRU in an MPCMI notification, wherein the MPCMI notification comprises ML model test vectors.

20. The method of claim 9, wherein the receiving a message including a WTRU identifier, ML model identifier and MPCER includes at least one of receiving MPCER information in an MPCER retrieve response from the WTRU or receiving MPCER information in an MPCER notification from the WTRU.
